(19) United States
(12) Patent Application Publication
(10) Pub. No.: US 2020/0149705 A1
(43) Pub. Date: May 14, 2020

(54) Rotatable crystal lamp

(71) Applicant: Shunhua Zhu, Jinhua City (CN)

(72) Inventor: Shunhua Zhu, Jinhua City (CN)

(21) Appl. No.: 16/745,294

(22) Filed: Jan. 16, 2020

(30) Foreign Application Priority Data
Aug. 27, 2019 (CN) 201910795920X

(51) Int. Cl. F21V 1/10; F16C 19/16

(52) U.S. Cl. CPC F21V 1/10; F16C 19/16

(57) ABSTRACT

The invention discloses a rotatable crystal lamp, which includes a lamp holder and a crystal lamp on the upper end face of the lamp holder, characterized in that a support block is provided on the upper side of the lamp holder and a support is provided on the upper end face of the lamp holder. The support column of the support block is provided with a crystal lamp cover on the upper side of the crystal lamp, and a driving cavity is provided in the support block. In the work of the present invention, the movement mode of the crystal lamp cover can be automatically switched to obtain different lighting effects. Improve the practicality and fun of the crystal lamp, through mechanical transmission, but also make the work efficiency to a certain degree improved.

### CROSS-REFERENCES TO RELATED APPLICATIONS

The present application claims priority from Chinese application No. 2019103152155 filed on Apr. 18, 2019 which is hereby incorporated by reference in its entirety.

### TECHNICAL FIELD

The invention relates to the field of crystal lamp, in particular to a rotatable crystal lamp.

### Background of the Invention

At this stage, some crystal lamps are provided with a crystal lampshade on the upper side, so that the light emitted by the crystal lamp produces different light and shadow effects. Most of these crystal lampshades need to be operated manually to make the light and shadow move, which requires a certain amount of labor. And when the angle between the crystal lampshade and the crystal lamp needs to be changed, manual operation is also required.

### Content of the Invention

The purpose of the present invention is to provide a rotatable crystal lamp to solve the problems raised in the background art mentioned above.

To achieve the above object, the present invention provides the following technical solution: a rotatable crystal lamp, comprising a lamp holder and a crystal lamp on the upper end face of the lamp holder, a support block is provided on the upper side of the lamp holder, and the lamp holder is provided on the lamp holder. A support post supporting the support block is provided on the end surface, a crystal lamp cover is provided on the upper side of the crystal lamp, a driving cavity is provided in the support block, and a rotation mechanism for controlling the rotation of the crystal lamp cover is provided in the driving cavity. The rotating mechanism includes a connecting rod connected at the lower end to the crystal lampshade, and a ball groove communicating with the external space and the driving cavity is provided in the lower end wall of the driving cavity, and the connecting rod penetrates in the ball groove. In the upper end wall of the driving cavity, two spring grooves with downward openings are provided in the upper end wall of the driving cavity, and a spring block with a lower end located in the driving cavity is provided in the spring groove. A first pulley connected by a first belt, the upper end of the connecting rod is frictionally driven with the first pulley on the right side, a circular groove is provided in the first pulley, and the lower end of the spring block penetrates the upper end wall of the circular groove And located in the circular groove a disk capable of supporting the first pulley is fixed at the lower end of the spring block, and a driving mechanism for powering the device is provided in the driving cavity, and the driving mechanism includes a motor and a driving shaft connected to the motor power. A sliding plate having a right end penetrated by the connecting rod is slidably connected to the transmission shaft. The moving plate is provided with a through-hole penetrated by the transmission shaft, and the transmission hole is provided with sliding with the transmission shaft. A cam that is connected and can move the moving plate to the left and right, a receiving groove that communicates with the through hole is provided in the cam, a flat key groove that communicates with the driving cavity is provided in the transmission shaft, and a flat key groove is provided in the flat shaft There is a flat key whose left end is located in the driving cavity and whose lower end can be located in the receiving slot through movement. A lifting plate is provided in the driving cavity, and a through slot penetrated by the transmission shaft is provided in the lifting plate. The upper end of the flat key is provided with a connecting post having an upper end penetrating the through slot, and an upper end of the connecting post is provided with a limiting block that restricts the downward movement of the flat key, and a rear end wall of the driving cavity is fixed by the transmission Shaft penetrates and supports Said support plate moving plate, action of the control means to control rotation of said first pulley to said connecting rod rotates Crystal shade, or pulls the moving plate, so that the change in the angle of the crystal globe.

Preferably, the rotation mechanism further includes a storage groove located in the first pulley on the left side and opening downwards. The left and right end walls of the storage groove are provided with ejection grooves, and the ejection grooves are provided with a trapezoidal block and an ejection spring capable of resetting the trapezoidal block, the upper end of the transmission shaft is located in the storage slot and two transmission slots capable of receiving the trapezoidal block are provided, and the spring slot is provided with The function of the rotating mechanism of the retractable spring of the spring block is to control the rotation of the first pulley on the right and transmit the power to the connecting rod through friction transmission, thereby controlling the rotation of the crystal lampshade.

Preferably, the transmission mechanism further includes a driven shaft whose upper end is connected to the upper end wall of the driving cavity, a lower end of the driven shaft is provided with a second pulley, and an upper end of the transmission shaft is provided with the second pulley through the first The third pulley connected by two belts is provided with a lifting rod at the left end of the lifting plate, a connecting plate at the upper end of the lifting rod, and a compression spring capable of resetting the connecting plate at the upper side of the connecting plate. The upper side of the two pulleys is provided with an inclined cylinder which is frictionally connected to the driven shaft and can control the connection plate and the first pulley on the right side to move up and down. An arc-shaped groove communicating with the driving cavity is provided in the inclined cylinder. The rear end wall of the driving cavity is further provided with a limit rod whose front end is located in the arc-shaped groove, and the role of the transmission mechanism is to provide power for the operation of the device.

In summary, the beneficial effects of the present invention are: the device has a simple structure, convenient operation, and can automatically switch the movement mode of the crystal lampshade, thereby obtaining different lighting effects, improving the practicality and interest of the crystal lamp. Transmission also improves work efficiency.

### BRIEF DESCRIPTION OF THE DRAWINGS

In order to more clearly illustrate the embodiments of the invention or the technical solutions in the prior art, the drawings used in the description of the embodiments or the prior art will be briefly introduced below. Obviously, the drawings in the following description are merely Some embodiments of the invention can be obtained by those skilled in the art based on these drawings without paying any creative labor. The following describes the present invention in detail with reference to FIGS. 1-4. For the convenience of description, the following orientations are defined as follows: The up-down, left-right, left-right, and front-back directions described below are consistent with the up-down, left-right, and left-right directions of the projection relationship of FIG. 1 itself.

FIG. 1 is a schematic front view of a crystal pendant lamp in accordance with the present invention, which can be easily cleaned;

FIG. 2 is an enlarged schematic left-side enlarged schematic view of a driven shaft structure of a crystal chandelier according to the present invention which is convenient for cleaning;

FIG. 3 is a partially enlarged front view of the crystal pendant lamp rotating mechanism which is easy to clean according to the present invention;

FIG. 4 is a partially enlarged front view of the crystal pendant lamp driving mechanism which is convenient for cleaning according to the present invention.

### DETAILED DESCRIPTION OF THE INVENTION

All of the features disclosed in this specification, or steps in all methods or processes disclosed, may be combined in any manner other than mutually exclusive features and/or steps.

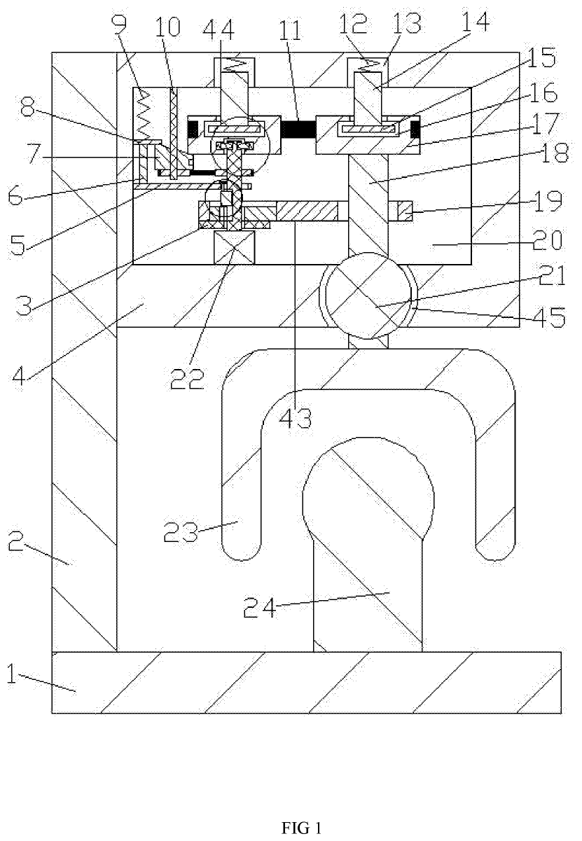

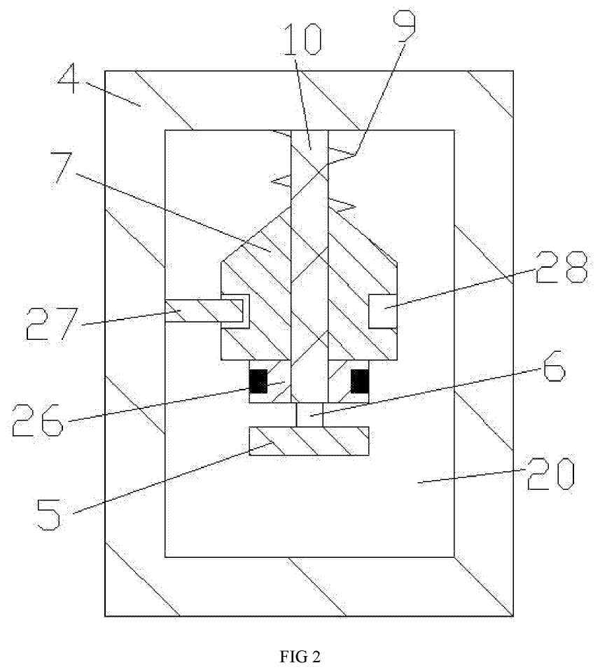

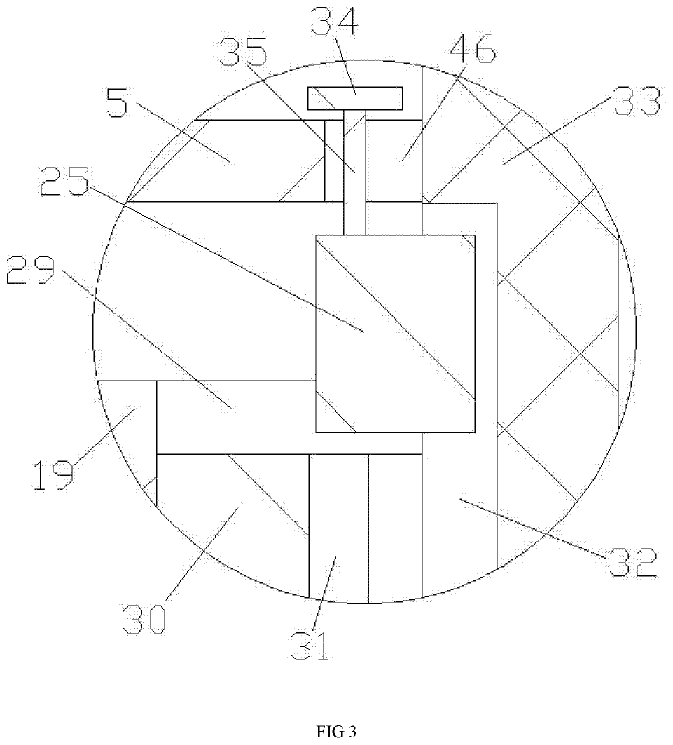

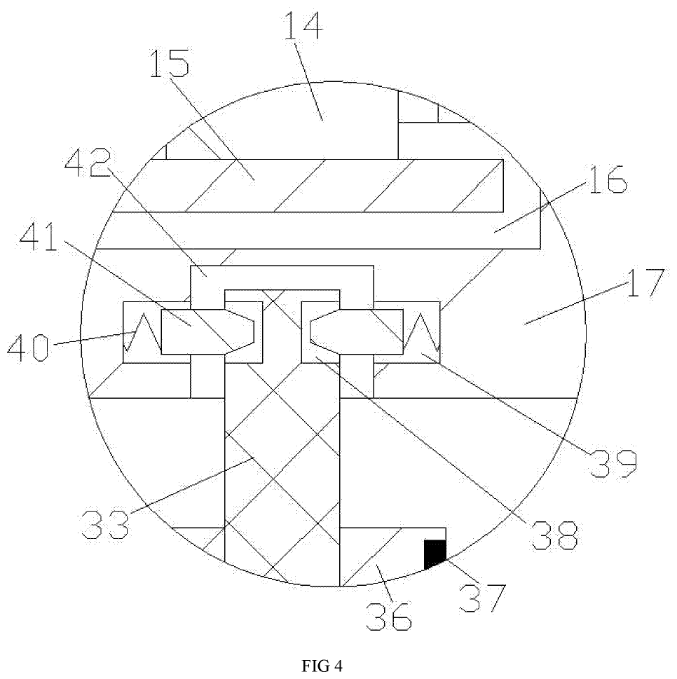

Please refer to FIGS. 1-4. An embodiment of the present invention provides a rotatable crystal lamp, which includes a lamp holder 1 and a crystal lamp 24 on an upper end surface of the lamp holder 1, and an upper side of the lamp holder 1 is provided. A support block 4 is provided on the upper end surface of the lamp holder 1 with a support post 2 supporting the support block 4, a crystal lamp cover 23 is provided on the upper side of the crystal lamp 24, and a driving cavity 20 is provided in the support block 4. A rotation mechanism 44 for controlling the rotation of the crystal lampshade 23 is provided in the driving cavity 20, and the rotation mechanism 44 includes a connecting rod 18 with a lower end connected to the crystal lampshade 23. The lower end wall of the driving cavity 20 is provided to communicate with the outside The space and the ball groove 45 of the driving cavity 20 are provided with a ball 21 through which the connecting rod 18 penetrates. Two upper spring walls 13 of the driving cavity 20 are downwardly opened. The spring groove 13 is provided with a spring block 14 having a lower end located in the driving cavity 20. The driving cavity 20 is provided with two first pulleys 17 connected to each other through a first belt 11. The upper end of the rod 18 is friction-transmitted with the first pulley 17 on the right side. The first pulley 17 is provided with a circular groove 16 therein, and the spring The lower end of 14 penetrates the upper end wall of the circular groove 16 and is located in the circular groove 16. The lower end of the spring block 14 is fixed with a disk 15 that can support the first pulley 17. The driving chamber 20 is provided with a device. A power transmission mechanism 43 is provided. The transmission mechanism 43 includes a motor 22 and a transmission shaft 23 that is dynamically connected to the motor 22. A sliding plate 19 having a right end penetrated by the connecting rod 18 is slidably connected to the transmission shaft 23. The moving plate 19 is provided with a through hole 29 penetrated by the transmission shaft 23. The transmission hole 29 is provided with a cam 30 slidably connected to the transmission shaft 23 and capable of moving the moving plate 19 left and right. A receiving groove 31 communicating with the through-hole 29 is provided in the cam 30, and a flat key groove 32 communicating with the driving cavity 20 is provided in the transmission shaft 33. A left end of the flat key groove 32 is located in the drive. The flat key 25 located in the receiving groove 31 can be moved in the cavity 20 and the lower end. The driving cavity 20 is provided with a lifting plate 5, and the lifting plate 5 is provided with a through slot penetrated by the transmission shaft 33. 46, the upper end of the flat key 25 is provided with a connecting post 35 having an upper end penetrating the through slot 46, so The upper end of the connecting column 35 is provided with a limiting block 34 which restricts the downward movement of the flat key 25, and a support plate 3 fixed to the rear wall of the driving cavity 20 is penetrated by the transmission shaft 33 and supports the moving plate 19. The function of the device is to control the rotation of the first pulley 17 to control the rotation of the connecting rod 18 and the crystal lampshade 23, or to pull the moving plate 19, so that the angle of the crystal lampshade 23 changes.

Beneficially, the rotating mechanism 44 further includes a storage slot 42 which is located in the first pulley 17 on the left side and opens downward. The left and right end walls of the storage slot 42 are provided with ejection slots 39, and the ejection slots The groove 39 is provided with a trapezoidal block 41 and an ejection spring 40 capable of resetting the trapezoidal block 41. The upper end of the transmission shaft 33 is located in the storage groove 42 and two sets of the trapezoidal block 42 are received. A transmission groove 38 is provided with a retractable spring 12 capable of resetting the spring block 14 in the spring groove 13. The function of the rotation mechanism 44 is to control the rotation of the first pulley 17 on the right side and to transfer the friction through the friction transmission. Power is transmitted to the connecting rod 18 to control the rotation of the crystal lampshade 23.

Advantageously, the transmission mechanism 43 further includes a driven shaft 10 whose upper end is connected to the upper end wall of the driving cavity 20, a second pulley 26 is provided at the lower end of the driven shaft 10, and an upper end of the transmission shaft 33 is provided with Said second pulley 26 is a third pulley 36 connected by a second belt 37. A left end of the lifting plate 5 is provided with a lifting rod 6, an upper end of the lifting rod 6 is provided with a connecting plate 8, and an upper side of the connecting plate 8 is provided. A compression spring 9 capable of resetting the connection plate 8 is provided on the upper side of the second pulley 26 with a frictional connection with the driven shaft 10 and can control the connection plate 8 to rise and fall with the first pulley 17 on the right side The beveled cylinder 7 is provided with an arc-shaped groove 28 in the bevel-shaped cylinder 7 which communicates with the driving cavity 20, and a rear end wall of the driving cavity 20 is further provided with a limiting rod 27 whose front end is located in the arc-shaped groove 28. The function of the transmission mechanism 43 is to provide power for the operation of the device.

In the following, the applicant will refer to the attached drawings 1-4 and the specific composition of a rotatable crystal lamp of the present application described above to describe in detail a method of using the rotatable crystal lamp of the present application:

When the crystal lampshade 23 needs to rotate, the motor 22 works to drive the transmission shaft 33 clockwise. The lower end of the flat key 25 is not located in the receiving groove 31. One end of the trapezoidal block 41 is located in the transmission groove 38. The rotation of the transmission shaft 33 drives the third pulley 36. With the rotation of the first pulley 17 on the left, through the transmission of the second belt 37 and the first belt 11, the second pulley 26 and the right first pulley 17 rotate, and the second pulley 26 drives the driven shaft 10 to rotate. Restricted by the lever 27, the inclined cylinder 7 does not rotate, and the rotation of the right first pulley 17 drives the connecting rod 18 to rotate, thereby driving the crystal lampshade 23 to rotate;

When the crystal lampshade 23 requires the angle between the cover surface and the crystal lamp 24, the motor 22 works to drive the transmission shaft 33 to rotate counterclockwise, and the third pulley 36 drives the second pulley 26 to rotate counterclockwise, thereby driving the inclined cylinder 7 to rotate, thereby making the left side The first pulley 17 rises, the telescopic spring 12 compresses, the connection plate 8 drops, and the compression spring 9 returns. When the connection plate 8 is lowered, the lifting rod 6 and the lifting rod 5 are lowered, so that the flat key 25 moves downward. When it is located on the same line as the receiving groove 31, the lower end of the flat key 25 enters the receiving groove 31. When the limit rod 27 contacts the end wall of the arc groove 28 again, the inclined cylinder 7 does not rotate, and the rotation of the transmission shaft 33 passes the flat key. The transmission of 25 causes the cam 30 to rotate, thereby causing the moving plate 19 to move left and right, thereby deflecting the upper end of the connecting rod 18, thereby adjusting the angle between the crystal lamp cover 23 and the crystal lamp 24. When the reset is required, the motor 22 works in the reverse direction. Reset the device.

The beneficial effects of the present invention are: the device has a simple structure, convenient operation, and can automatically switch the movement mode of the crystal lampshade, thereby obtaining different lighting effects, improving the practicability and interest of the crystal lamp. Through mechanical transmission, it also makes Work efficiency has been improved.

The above is only the specific embodiment of the invention, but the scope of the invention is not limited thereto, and any changes or substitutions that are not thought of by the creative work are included in the scope of the invention. Therefore, the scope of protection of the invention should be determined by the scope of protection defined by the claims.

1. A rotatable crystal lamp includes a lamp holder and a crystal lamp on the upper end face of the lamp holder, characterized in that a support block is provided on the upper side of the lamp holder, and a support block is provided on the upper end face of the lamp holder. A support column, a crystal lamp cover is provided on the upper side of the crystal lamp, a driving cavity is provided in the support block, and a rotation mechanism for controlling the rotation of the crystal lamp cover is provided in the driving cavity, and the rotation mechanism includes a lower end and a In the connecting rod connected by the crystal lampshade, a ball groove connecting the external space and the driving cavity is provided in the lower end wall of the driving cavity, and a ball passing through the connecting rod is provided in the ball groove, and the upper end of the driving cavity is provided. The wall is provided with two spring grooves which are opened downward. The spring groove is provided with a spring block whose lower end is located in the driving cavity, and the driving cavity is provided with two first A pulley, the upper end of the connecting rod is friction-transmitted with the first pulley on the right side, a circular groove is provided in the first pulley, and the lower end of the spring block penetrates the upper end wall of the circular groove and is located in the circular groove, A supportable part is fixed at the lower end of the spring block A disk supporting the first pulley is provided in the driving cavity with a transmission mechanism for powering the device. The transmission mechanism includes a motor and a transmission shaft that is dynamically connected to the motor. A sliding shaft is connected to the transmission shaft. A moving plate with a right end penetrated by the connecting rod, a through hole penetrating through the transmission shaft is provided in the moving plate, and a sliding connection with the transmission shaft is provided in the transmission hole and the moving plate can be left and right A moving cam, a receiving groove communicating with the through hole is provided in the cam, a flat key groove communicating with the driving cavity is provided in the transmission shaft, and the left end of the flat key groove is located in the driving cavity and The lower end can be moved by a flat key located in the receiving slot. A lifting plate is provided in the driving cavity. The lifting plate is provided with a through slot penetrated by the transmission shaft. The upper end of the flat key is provided with an upper end penetration. The connecting column of the through slot is provided with a limiting block at the upper end of the connecting column to limit downward movement of the flat key, and a rear end wall of the driving cavity is fixed with a driving shaft that penetrates and supports the moving plate. Support plate, the device It is to control the rotation of the first pulley so as to control the connecting rod and the rotatable Crystal shade, or pulls the moving plate, so that the change in the angle of the crystal globe.

2. The rotatable crystal lamp according to claim 1, wherein the rotating mechanism further comprises a storage groove located in the first pulley on the left side and opening downward, and inside the left and right end walls of the storage groove Each is provided with an ejection slot, and a trapezoidal block and an ejection spring capable of resetting the trapezoidal block are provided in the ejection slot. The transmission groove of the trapezoidal block is provided with a telescopic spring capable of resetting the spring block in the spring groove, and the function of the rotation mechanism is to control the rotation of the first pulley on the right side and transmit power through friction transmission. Give the connecting rod to control the rotation of the crystal lampshade.

3. The rotatable crystal lamp according to claim 1, wherein the transmission mechanism further comprises a driven shaft whose upper end is connected to the upper end wall of the driving cavity, and a second pulley is provided at the lower end of the driven shaft. A third pulley connected with the second pulley through a second belt is provided at the upper end of the transmission shaft, a lift rod is provided at the left end of the lifting plate, a connecting plate is provided at the upper end of the lifting rod, and the connecting plate is on the upper side A compression spring capable of resetting the connection plate is provided, and an upper side of the second pulley is provided with an inclined cylinder which is frictionally connected with the driven shaft and can control the connection plate and the first pulley on the right side to rise and fall, An arc-shaped groove communicating with the driving cavity is provided in the beveled cylinder, and a limiting rod located in the arc-shaped groove at the front end of the driving cavity is also provided. The function of the transmission mechanism is to operate the device. Provide power.
